(19) United States
(12) Patent Application Publication
(10) Pub. No.: US 2021/0172555 A1
(43) Pub. Date: Jun. 10, 2021

(54) MULTIPLE SEALED AND ARTICULATED FLUIDIC CONNECTIONS FORMED BY NESTED RIGID ELEMENTS

(71) Applicant: SOGEFI AIR & COOLING, Guyancourt (FR)

(72) Inventors: Boris COLIN, ORBEY (FR); Arnaud SCHUB, INGERSHEIM (FR)

(21) Appl. No.: 17/067,621

(22) Filed: Oct. 9, 2020

Related U.S. Application Data
(60) Provisional application No. 62/913,917, filed on Oct. 11, 2019.

(51) Int. Cl. F16L 41/03; F16L 41/18; F16K 11/08

(52) U.S. Cl. CPC F16L 41/03; F16K 11/08; F16L 41/18

(57) ABSTRACT

The invention concerns a system for the circulation of fluid between at least one first body or housing (2) and at least one second body or housing (3), comprising an arrangement of multiple fluidic connections (4, 4′, 4″, 4′″) between, on the one hand, said first body or housing (2) provided with at least two mutually distinct openings (5, 5′, 5″, 5′″) and, on the other hand, at least one second body or housing (3) also having mutually distinct openings, each connection establishing a leaktight fluidic connection between an opening of the first body or housing (2) and an opening of the second body or housing (3), or of one of the second bodies or housings.

In this system (1), each of the fluidic connections (4, 4′, 4″, 4′″) is of a rigid but articulated type, and formed by successive nestings of a rigid female manifold (7, 7′, 7″, 7′″), a rigid duct or diabolo (9, 9′, 9″, 9′″) and a rigid male fitting (8, 8′, 8″, 8′″).

The invention concerns the field of fluid circulation circuits, in particular the controlled circulation of liquid fluids.

In such a context, and in particular in an environment under the hood of a motor vehicle with an internal combustion engine, it aims to provide a system for the circulation of fluid between at least two hollow bodies or housings, by establishing multiple leaktight fluidic connections between such bodies, which may have variable relative arrangements (in particular with connection faces that are not opposite each other).

The aforementioned connections should also be able to take up manufacturing and assembly tolerances and also deformations during operation.

A fluid circulation system as mentioned above is generally composed of at least two, usually several, functional housings that are connected to each other. The reference faces to which these functional housings are attached and connected are not necessarily the same. To this must be added the manufacturing tolerances of the different functional housings of the circuit and small functional deformations (expansion, pressure variations, etc.). It is then a question of:—connecting the different functional housings to each other with the need to make up for these tolerances,—having a certain flexibility to absorb small functional deformations (expansion, pressure variations, vibrations, etc.), while ensuring the leaktightness of the circulation system (i.e. of the internal fluid with respect to the outside).

This function is usually performed by elastomer-based tubes (commonly referred to as “hoses”) that have good flexibility and sealing features.

The distances/routes between the different interfaces may be varied and may therefore require the management of a large variety of hose references.

In addition, it is recommended to provide at least one additional intermediate attachment (between its two connected ends) in the event of significant length, non-rectilinear shape and/or sensitive environment.

Moreover, the automation, or even the simple mechanization, of the mounting of flexible hoses is difficult and delicate. It is often necessary to resort to completely manual mounting. This is all the more so since a leaktight connection requires the installation of a collar, and the press fitting thereof onto a specially shaped fitting (olive fitting).

The present invention is intended to compensate for these drawbacks.

To this end, the main subject of the invention is a system for the circulation of fluid between at least one first body or housing and at least one second body or housing, comprising an arrangement of multiple fluidic connections between, on the one hand, said first body or housing provided with at least two mutually distinct openings and, on the other hand, at least one second body or housing also having mutually distinct openings, each connection establishing a leaktight fluidic connection between an opening of the first body or housing and an opening of the second body or housing, or of the second bodies or housings,

wherein, in said system
each of the fluidic connections is of a rigid but articulated type, each relevant opening of the first body or housing is provided with a corresponding straight, curved or angled rigid female manifold, and each relevant opening of the second body or housing, or of the second bodies or housings, is provided with a corresponding rigid male fitting, and
rigid ducts or diabolos of suitable shape are nested, on the one hand, in respective female manifolds of the first body or housing and, on the other hand, on respective male fittings of the second body or housing or of the second bodies or housings,
each nested [manifold/duct/fitting] assembly, formed of mutually nested tubular elements made of rigid plastic material, forming a leaktight fluidic connection provided with at least a limited capability of relative rotational/translational/angular displacement, at least at the relevant [manifold/duct] nesting, and possibly also at the relevant [duct/fitting] nesting.

The invention will be better understood through the following description, which relates to a preferred embodiment, given as a nonlimiting example, and explained with reference to the appended schematic drawings, in which:

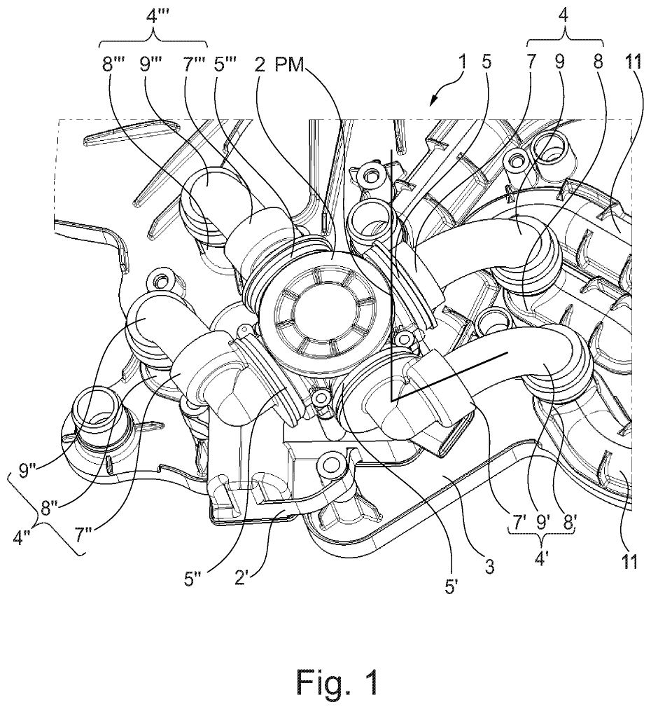

FIG. 1 shows a partial top perspective view of a fluid (liquid) circulation system in accordance with one embodiment of the invention, comprising a first functional housing in the form of a valve or distributor housing and a second body in the form of a distributor plate;

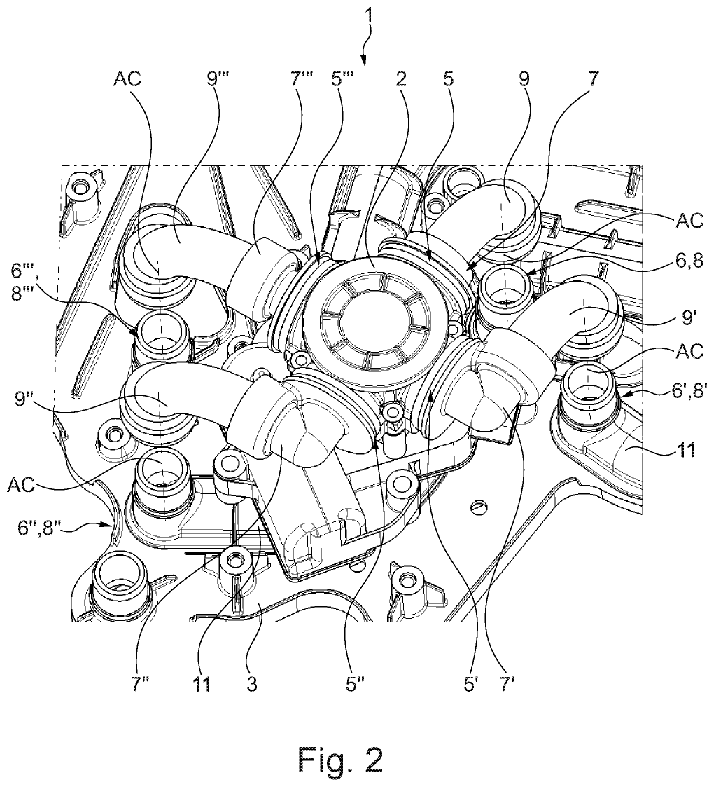

FIG. 2 is a view similar to that in FIG. 1, with the pre-mounted module incorporating the valve (housing+actuator) about to be assembled with the distributor plate to form the circulation system;

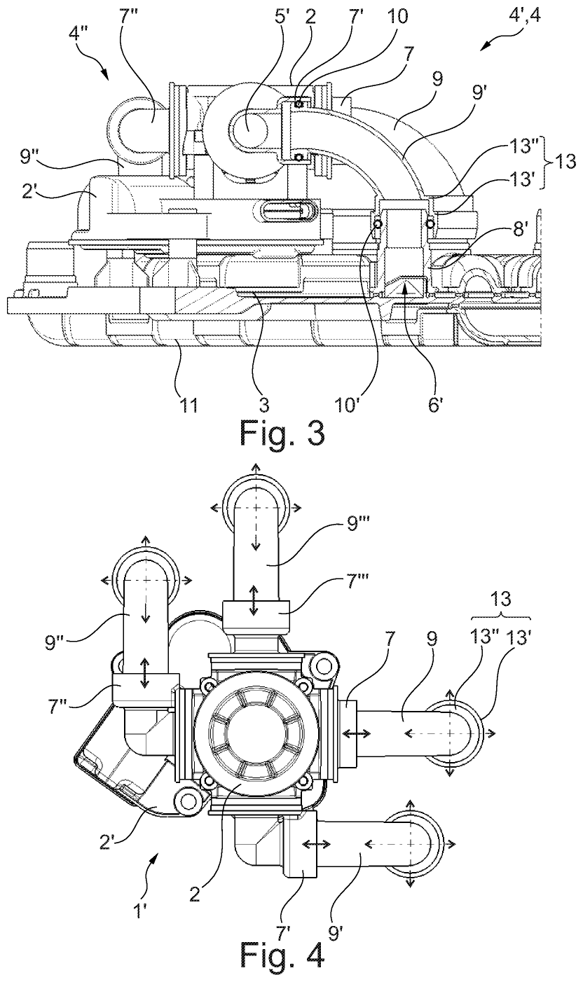

FIG. 3 shows a detail view of one of the fluidic connections of the system shown in FIG. 1, on a different scale and in section on the plane PM;

FIG. 4 is a top view of the pre-mounted module in FIG. 2, illustrating the limited articulation and relative displacement capabilities at the nested interfaces;

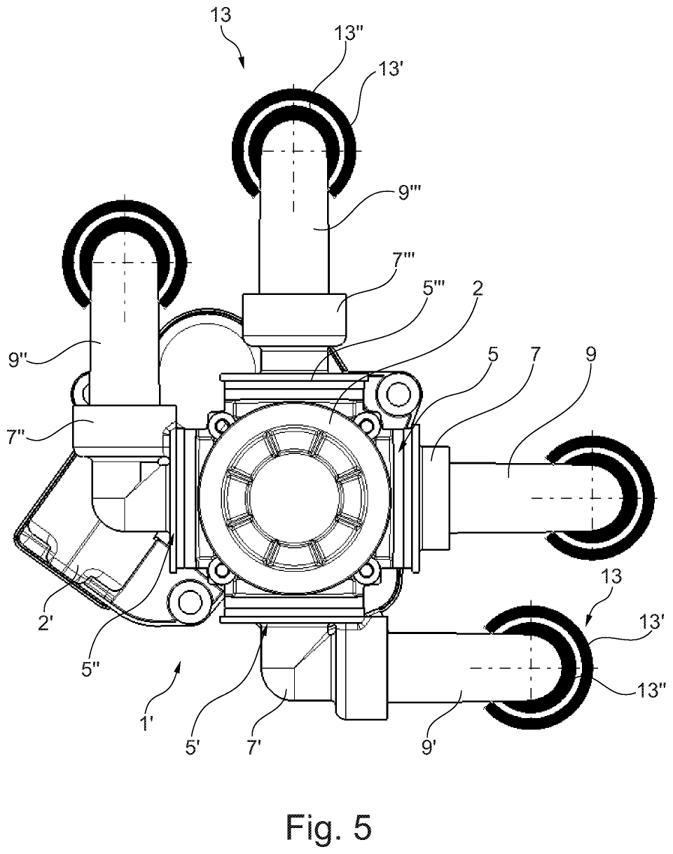

FIG. 5 is a top view of the pre-mounted module similar to that in FIG. 4, but on a different scale and with the gripping and support zones highlighted;

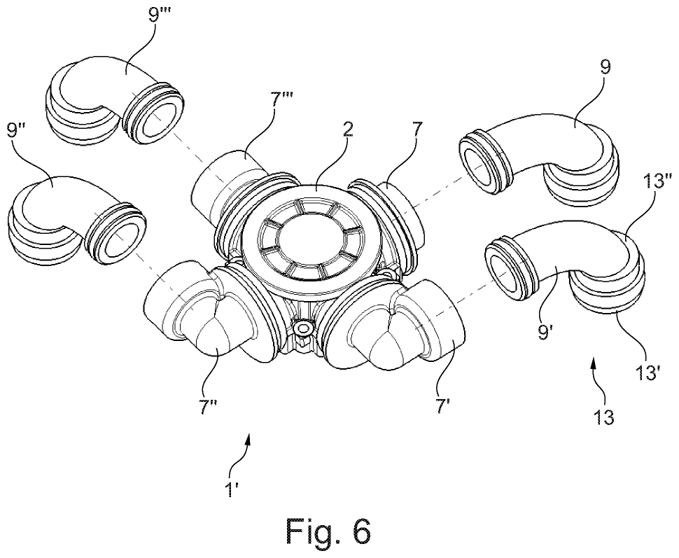

FIG. 6 is a perspective and partially exploded view of the module shown in FIG. 5 (but not including the actuator, possible pre-mounting variant of the module), and,

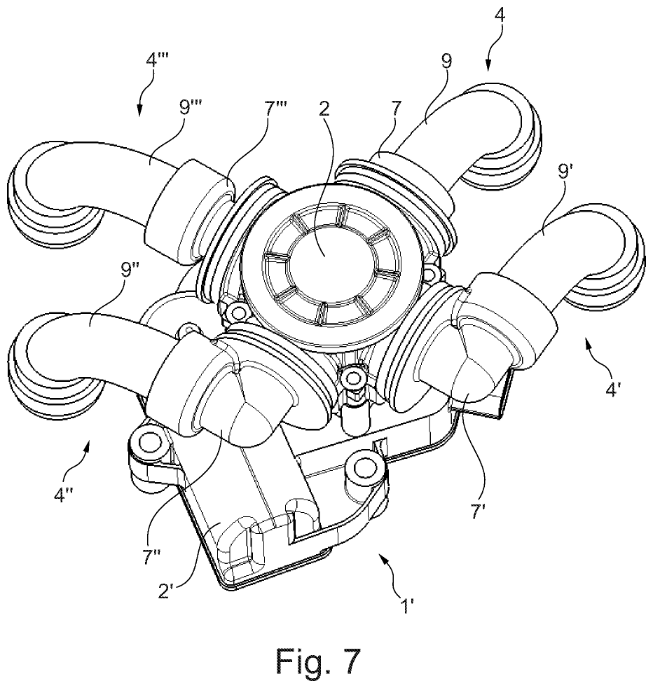

FIG. 7 is a perspective view of the pre-mounted module in FIGS. 4 to 6, also incorporating the actuator, according to a variant embodiment.

FIGS. 1 to 3 show, at least in part, a system (1) for the circulation of fluid between at least one first body or housing (2) and at least one second body or housing (3), comprising an arrangement of multiple fluidic connections (4, 4′, 4″, 4′″) between, on the one hand, said first body or housing (2) provided with at least two mutually distinct openings (5, 5′, 5″, 5′″) and, on the other hand, at least one second body or housing (3) also having mutually distinct openings (6, 6′, 6″, 6′″), each connection establishing a leaktight fluidic connection between an opening of the first body or housing (2) and an opening of the second body or housing (3), or of one of the second bodies or housings.

According to the invention, in this system (1), each of the fluidic connections (4, 4′, 4″, 4′″) is of a rigid but articulated type, each relevant opening (5, 5′, 5″, 5′″) of the first body or housing (2) is provided with a corresponding rigid straight, curved or angled female manifold (7, 7′, 7″, 7′″), and each relevant opening (6, 6′, 6″, 6′″) of the second body or housing (3), or of the second bodies or housings, is provided with a corresponding rigid male fitting (8, 8′, 8″, 8′″), and rigid ducts or diabolos (9, 9′, 9″, 9′″) of suitable shape are nested, on the one hand, in respective female manifolds (7, 7′, 7″, 7′″) of the first body or housing (2) and, on the other hand, on respective male fittings (8, 8′, 8″, 8′″) of the second body or housing or of the second bodies or housings (3).

By virtue of these arrangements, each nested [manifold (7, 7′, 7″, 7′″)/duct (9, 9′, 9″, 9′″)/fitting (8, 8′, 8″, 8′″)] assembly, formed of mutually nested tubular elements made of rigid plastic material, forms a leaktight fluidic connection (4, 4′, 4″, 4′″) provided with at least a limited capability of relative rotational/translational/angular displacement, at least at the relevant [manifold/duct] nesting, and possibly also at the relevant [duct/fitting] nesting.

Thus, each fluidic connection comprises three rigid tubular segments of different types (manifolds, ducts, fittings), connected fluidically and mechanically in series in pairs via nested connections, providing a possibility of limited articulation at each nesting of two consecutive segments. The articulation provides a limited capability of relative displacement between two mutually nested segments, this possible displacement being rotational and/or translational, or being able to comprise a movement component changing the orientation between the relevant segments (swiveling). In order to allow these relative articulation movements, the interlocked male and female tubular portions at the nestings have sufficient radial clearances, suitable sealing means being interposed between these portions and, if necessary, guiding the relative displacement. The different nested connections are configured to allow each an axial tolerance management of approximately +/−3 mm and swiveling with an amplitude suitable for establishing the portions of circulation lines (fluidic connections (4, 4′, 4″, 4′″)), with a seal being maintained under fluid pressures of 2 to 3 bar.

Due to the segmentation of the fluidic connections, complex shapes may be obtained with a limited number of different tubular elements and simple shapes: straight, angled, curved. Furthermore, the rigidity of said elements, in particular of the tubes (9, 9′, 9″, 9′″), makes it possible to dispense with any intermediate attachment and to automate the assembly of the system (1), due to the possibility of a secure grip, precise positioning and transmission of forces during nesting.

The advantages of the invention are particularly beneficial when the arrangement of multiple fluidic connections comprises at least three, preferably at least four, distinct fluidic connections (4, 4′, 4″, 4′″).

In order to compensate in particular for manufacturing and assembly discrepancies, it is advantageously provided that each leaktight fluidic connection (4, 4′, 4″, 4′″) has a limited articulation capability at least at its respective [manifold (7, 7′, 7″, 7′″)/duct (9, 9′, 9″, 9′″)] nesting, and possibly also at its respective [duct (9, 9′, 9″, 9′″)/fitting (8, 8′, 8″, 8′″)] nesting.

In order to make it easier to assemble the system (1) and in particular to allow all the nestings of the ducts on the fittings to be obtained simultaneously, the rigid male fittings (8, 8′, 8″, 8′″) of the second body or housing or of the second bodies or housings (3) all have a straight or rectilinear composition and the same orientation, their central axes (AC) being parallel to each other.

Each [manifold/duct] pair is thus configured, by choosing tubular segments (7, 7′, 7″, 7′″) and (9, 9′, 9″, 9′″) of appropriate shapes and sizes and by choosing suitable orientations, in such a way that the female ends (13) of the ducts are all positioned opposite the fittings so as to allow synchronous assembly by multiple duct-manifold nestings during a single translational movement of said ducts.

As shown in FIGS. 1 to 3, the face or faces of the first body (2) having the openings (5, 5′, 5″, 5″), on the one hand, and the face or faces of the second body or second bodies (3) having the openings (6, 6′, 6″, 6′″), on the other hand, are, for example, oriented perpendicularly to each other. Advantageously, the relevant faces of the first body (2) are side faces of the latter, located on several sides and oriented, relative to the arrangements of the openings to be connected of the second body or of the second bodies (3), in such a way that the fluidic connections have simple shapes, with only one curve/angle (cf. 4 and 4′″: curved ducts 9 and 9′″) or at most two curves/angles in two different planes (cf. 4′ and 4″: angled manifolds 7′ and 7″ and curved ducts 9′ and 9″).

According to another feature of the invention, the rigid female manifolds (7, 7′, 7″, 7′″) consist of tubular (for example straight or curved) connectors attached at the respectively relevant openings (5, 5′, 5″, 5′″) of the first body or housing (2), being rigidly secured (to said body or housing), for example by welding.

According to another feature of the invention, as shown in FIGS. 3 and 4, it is advantageously provided that at least one, and preferably each [manifold (7, 7′, 7″, 7′″)/duct (9, 9′, 9″, 9′″)] nesting is configured to allow limited swiveling, while maintaining the seal at the relevant nesting.

As an alternative or in addition to the foregoing provision, it may be provided for at least one, and preferably each, [manifold (7, 7′, 7″, 7′″)/duct (9, 9′, 9″, 9′″)] nesting to be configured to also allow limited relative axial displacement (between the nested manifold and duct), while maintaining the seal at the relevant nesting.

The two previous provisions make it possible, each in its own way, to easily accommodate geometric and dimensional discrepancies during multiple assemblies between corresponding ducts and fittings.

In addition, in order to have an adjustment/compensation capability in the nesting direction, it may also be envisioned that at least one, and preferably each, [duct (9, 9′, 9″, 9′″)/fitting (8, 8′, 8″, 8′″)] nesting allows at least limited axial displacement, while maintaining the seal at the relevant nesting.

Preferably, a compression seal (10, 10′), for example an O-ring or lip seal(s) made of elastomer material, is present at each [manifold (7, 7′, 7″, 7′″)/duct (9, 9′, 9″, 9′″)] nesting, and preferably also at each [duct (9, 9′, 9″, 9′″)/fitting (8, 8′, 8″, 8′″)] nesting, so as to obtain an axial and/or radial seal depending on the nesting in question. An O-ring 10 may advantageously promote or guide the limited swiveling between the mutually nested manifold and duct.

According to a first variant embodiment of the invention, each [duct (9, 9′, 9″, 9′″)/fitting (8, 8′, 8″, 8′″)] nesting, and advantageously also each [manifold (7, 7′, 7″, 7′″)/duct (9, 9′, 9″, 9′″)] nesting, comprises a releasable locking means (12). The latter may, for example, consist of a key, clip, circlip, screw or similar fastening and locking element.

In accordance with another variant embodiment of the invention, each [duct (9, 9′, 9″, 9′″)/fitting (8, 8′, 8″, 8′″)] nesting may also be locked by welding, in particular friction or vibration welding, the seal at this nesting being obtained either directly by said welding connection or by interposition of a compression seal (10′).

According to a very advantageous design feature of the invention, illustrated in FIGS. 3, 5 and 6 and favorable to mounting in terms of handling, positioning and assembly, the female end (13) of each duct (9, 9′, 9″, 9′″) assembled by nesting with a male fitting (8, 8′, 8″, 8′″) comprises at least one gripping zone (13′), for example in the form of a cylindrical skirt portion, and at least one support zone (13″), for example in the form of at least one shoulder.

By providing a double shoulder at the ends (13) of the ducts, as illustrated in the aforementioned figures, it is possible to spatially differentiate the gripping and support functions, or to have a double support zone.

In order to make it easier to handle and assemble the different constituent elements of the system (1), and also to make it easier to automate these operations, it is preferably provided, as shown in FIGS. 2 and 4 to 6, that the first body or housing (2), together with the different pairs of mutually nested tubular elements [manifolds/ducts] associated therewith, forms a pre-assembled unit (1′) of the pre-mounted structural and functional module type. To obtain the system (1), all that is then required is to assemble this module (1′) with the second body or second bodies (3) by nesting the female ends (13) of the ducts on the fittings.

According to a preferred implementation of the invention, in connection with a circulation system (1) used for liquid fluid and installed under the hood, the first body (2) consists of an at least two-way, preferably three- or four-way, distributor valve body, and the second body (3) consists of a distributor plate, preferably of the type incorporating ducts (11) that are rigidly connected to each other, are advantageously located substantially in the same plane and each end at one of their ends with a respective fitting (8, 8′, 8″, 8′″).

As shown in FIGS. 1, 3 and 7, an actuator (2′), mounted in a protective housing, is associated with the valve body (2)—enclosing the chamber and the distributor member—and the two together form a valve controlling the distribution and circulation of fluid between the different lines of leaktight fluidic connections (4, 4′, 4″, 4′″). This actuator (2′) is positioned under the valve body (2), between the latter and the second body (2), to which said actuator (2′) is advantageously attached. The result is a compact, low-profile construction with easy access to the fluidic connections and a firm connection between the module (1′) and the second body (3).

The invention further relates, as shown in FIGS. 2 and 4 to 6, to a fluidic module (1′) intended to form part of a fluid circulation system (1) as described above.

This module (1′) consists of a pre-assembled structural and functional unit (1′) incorporating, on the one hand, a first body or housing (2) provided with at least two distinct openings (5, 5′, 5″, 5′″) each provided with a corresponding straight, curved or angled rigid female manifold (7, 7′, 7″, 7′″) and, on the other hand, rigid ducts or diabolos (9, 9′, 9″, 9′″) with suitable shapes, which are nested respectively in said different female manifolds (7, 7′, 7″, 7′″). These different pairs of mutually nested rigid tubular elements [manifolds (7, 7′, 7″, 7′″)/ducts (9, 9′, 9″, 9′″)] are configured so as to each form, in cooperation by nesting with a respective male fitting (8, 8′, 8″, 8′″) of at least one second body or housing (3), a leaktight fluidic connection (4, 4′, 4″, 4′″) provided with at least a limited capability of relative rotational/translational/angular displacement, between these first and second bodies or housings (2 and 3).

The different combinations of nested tubular [manifold/duct] segments are shaped and sized in such a way that the female ends (13) of the ducts (9, 9′, 9″, 9′″), which are intended to be assembled by nesting with the male fittings (8, 8′, 8″, 8′″), are arranged with respect to each other and positioned relative to the first body or housing (2) so as to reproduce, within manufacturing tolerances and with limited adjustability, the mutual arrangement of the respectively corresponding male fittings (8, 8′, 8″, 8′″) of the second body or housing (3) and their positioning relative to the latter.

Lastly, the invention further relates to a method for producing a system (1) for the circulation of fluid between at least one first body or housing (2) and at least one second body or housing (3).

As indicated above, this system (1) comprises an arrangement of multiple fluidic connections (4, 4′, 4″, 4′″) between, on the one hand, said first body or housing (2) provided with at least two distinct openings (5, 5′, 5″, 5′″) and, on the other hand, at least one second body or housing (6) having distinct openings (6, 6′, 6″, 6′″), each connection establishing a leaktight fluidic connection between an opening of the first body or housing (2) and an opening of the second body or housing (3), or of one of the second bodies or housings.

This method consists in:
providing a first body or housing (2), each opening (5, 5′, 5″, 5′″) of which is provided with a corresponding straight, curved or angled rigid female manifold (7, 7′, 7″, 7′″), at least one second body or housing (3), each opening (6, 6′, 6″, 6′″) of which is provided with a corresponding rigid male fitting (8, 8′, 8″, 8′″), and rigid ducts or diabolos (9, 9′, 9″, 9′″) of suitable shape, configured to be nested, on the one hand, in respective female manifolds (7, 7′, 7″, 7′″) of the first body or housing (2) and, on the other hand, on respective male fittings (8, 8′, 8″, 8′″) of the second body or housing or of the second bodies or housings (3), and
producing nested [manifold/duct/fitting] assemblies, formed of mutually nested tubular elements made of rigid plastic material, each forming a leaktight fluidic connection (4, 4′, 4″, 4′″) and each provided with at least a limited capability of relative rotational/translational/angular displacement, at least at the relevant [manifold/duct] nesting, and optionally also at the relevant [duct/fitting] nesting, so as to obtain fluidic connections (4, 4′, 4″, 4′″) of a rigid but articulated type.

Advantageously, this method may consist, in a separate and preliminary operating phase, in producing a pre-mounted structural and functional module (1′) either by assembling the first body or housing (2) with the different pairs of mutually pre-nested tubular elements [manifold/duct] associated therewith, or by assembling the female manifolds (7, 7′, 7″, 7′″) with said first body or housing (2), then assembling the rigid ducts or diabolos (9, 9′, 9″, 9′″) by nesting them with the respectively corresponding manifolds (7, 7′, 7″, 7′″), and then in assembling this module (1′) mechanically and fluidically, by mounting in a direction parallel to the central axes of the rigid straight male fittings (8, 8′, 8″, 8′″) and multiple nestings of the rigid ducts or diabolos (9, 9′, 9″, 9′″) on these fittings (8, 8′, 8″, 8′″), with said at least one second body or housing (3) to form the fluid circulation system (1).

Preferably, the assembly of the pre-mounted module (1′) with said at least one second body or housing (3) is carried out at a robotic station, either in a fully automated manner by an autonomous robot, or in a semi-automated manner by a collaborative or assistance robot.

In the context of a particularly advantageous implementation, the method for producing a system (1) as mentioned above aims to provide a method comprising a first phase of assembling a module (1′) incorporating at least part of a multi-way distributor valve (2) and a second phase of mounting this pre-assembled module (1′) on a distributor plate (3), this being done by simply nesting the ducts of the module on the fittings of the plate, if necessary using a suitable tool, and optionally in an at least partially automated manner. The module (1′) may preferably comprise the entire valve, i.e. the valve body (2) and the actuator (2′), as shown in FIGS. 5 and 7, or, as shown in FIG. 6, only the valve body. In the latter case, the actuator (2′) may be pre-mounted on the second body (3) and the assembly of the valve body with the actuator (to form the functional valve) is done when mounting the module (1′) on the second body (3).

The fluid circulation system (1) described above mainly and simultaneously fulfills the following functions:
connecting the different functional housings to each other with the possibility of compensating for manufacturing and mounting/assembly tolerances,
having a certain flexibility to absorb small functional deformations (expansion, pressure variations, etc.)
while at the same time ensuring leaktightness of the circulation system (internal fluid with respect to the outside).

The compensation of tolerances and the flexibility to absorb small functional deformations are allowed by functional clearances at the two articulated nestings of each of the ducts, which will allow the duct in question to slide and/or swivel at these nested connection interfaces.

In the context of increasing ergonomic requirements (mounting force, simplification of assembly), the automation of the assembly of the modules (1′) or the assembly of the modules (1′) on the plates (3) is a clear advantage. The concept according to the invention of rigid tubular segments makes this automation possible since a force applied to such a segment will, by the very rigidity of this segment, be converted into an assembly/insertion/nesting force of this same segment (this is more particularly valid for the ducts).

If necessary, each articulated nesting may be locked by a retaining means (see the examples mentioned above), which will make it possible, for example, to prevent the module (1′) or system (1) from coming apart under pressure, or being disassembled, during transport or handling.

The constituent materials of the different components (1) of the system are thermoplastic materials. Thus, for example, the housing body (2), the manifolds, the fittings and the diabolos may be made of PP-GF10, the housing body or plate (3) of PA66-GF30 and the seals (10 and 10′) of EPDM rubber.

Of course, the invention is not limited to the embodiment described and depicted in the appended drawings. Modifications remain possible, in particular from the point of view of the composition of the various elements or by substitution of technical equivalents, without departing from the scope of protection of the invention.

1. A system for the circulation of fluid between at least one first body or housing and at least one second body or housing, comprising:
an arrangement of multiple fluidic connections between, on the one hand, said first body or housing provided with at least two mutually distinct openings and, on the other hand, at least one second body or housing also having mutually distinct openings, each connection establishing a leaktight fluidic connection between an opening of the first body or housing and an opening of the second body or housing, or of one of the second bodies or housings,
wherein, in said system, each of the fluidic connections is of a rigid but articulated type, each relevant opening of the first body or housing is provided with a corresponding straight, curved or angled rigid female manifold, and each relevant opening of the second body or housing, or of the second bodies or housings, is provided with a corresponding rigid male fitting, and
rigid ducts or diabolos of suitable shape are nested, on the one hand, in respective female manifolds of the first body or housing and, on the other hand, on respective male fittings of the second body or housing or of the second bodies or housings, each nested assembly, formed of mutually nested tubular elements made of rigid plastic material, forming a leaktight fluidic connection provided with at least a limited capability of relative rotational/translational/angular displacement, at least at the relevant manifold/duct nesting, and possibly also at the relevant duct/fitting nesting.

2. The fluid circulation system as claimed in claim 1, wherein the arrangement of multiple fluidic connections comprises at least three, distinct fluidic connections.

3. The fluid circulation system as claimed in claim 1, wherein each leaktight fluidic connection has a limited articulation capability at least at its respective manifold/duct nesting and possibly also at its respective duct/fitting nesting.

4. The fluid circulation system as claimed in claim 1, wherein the rigid male fittings of the second body or housing or of the second bodies or housings all have a straight or rectilinear shape and the same orientation, their central axes being parallel to each other.

5. The fluid circulation system as claimed in claim 1, wherein the rigid female manifolds have tubular connectors attached at the respectively relevant openings of the first body or housing, being rigidly secured, for example by welding.

6. The fluid circulation system as claimed in claim 1, wherein at least one manifold/duct nesting is configured to allow limited swiveling, while maintaining the seal at the relevant nesting.

7. The fluid circulation system as claimed in claim 6, wherein at least one manifold/duct nesting is configured to also allow limited relative axial displacement, while maintaining the seal at the relevant nesting.

8. The fluid circulation system as claimed in claim 1, wherein at least one duct/fitting nesting allows at least limited axial displacement, while maintaining the seal at the relevant nesting.

9. The fluid circulation system as claimed in claim 1, wherein a compression seal, for example an O-ring or lip seal(s) made of elastomeric material, is present at each manifold/duct nesting, and preferably also at each nesting, so as to obtain an axial and/or radial seal depending on the nesting in question.

10. The fluid circulation system as claimed in claim 1, wherein each duct/fitting nesting is locked by welding, in particular friction or vibration welding, the seal at this nesting being obtained either directly by said welding connection or by interposition of a compression seal.

11. The fluid circulation system as claimed in claim 1, wherein each duct/fitting nesting, and each manifold/duct nesting, comprises a releasable locking means.

12. The fluid circulation system as claimed in claim 1, wherein the female end of each duct assembled by nesting with a male fitting comprises at least one gripping zone, for example in the form of a cylindrical skirt portion, and at least one support zone, for example in the form of at least one shoulder.

13. The fluid circulation system as claimed in claim 1, wherein the first body has an at least two-way, distributor valve body, and wherein the second body has a distributor plate, are located substantially in the same plane and each end at one of their ends with a respective fitting.

14. The fluid circulation system as claimed in claim 1, wherein the first body or housing, together with the different pairs of mutually nested tubular elements manifold/ducts associated therewith, forms a pre-assembled unit of the pre-mounted structural and functional module type.

15. A fluidic module intended to form part of a fluid circulation system as claimed in claim 1, said fluidic module having a pre-assembled structural and functional unit incorporating, on the one hand, a first body or housing provided with at least two distinct openings each provided with a corresponding straight, curved or angled rigid female manifold and, on the other hand, rigid ducts or diabolos of suitable shapes, which are nested respectively in said different female manifolds, these different pairs of mutually nested rigid tubular elements manifolds/ducts being configured so as to each form, in cooperation by nesting with a respective male fitting of at least one second body or housing, a leaktight fluidic connection, provided with at least a limited capability of relative rotational/translational/angular displacement, between these first and second bodies or housings.

16. The fluidic module as claimed in claim 15, wherein the female ends of the ducts, which are intended to be assembled by nesting with the male fittings, are arranged with respect to each other and positioned relative to the first body or housing so as to reproduce, within manufacturing tolerances and with limited adjustability, the mutual arrangement of the respectively corresponding male fittings of the second body or housing and their positioning relative to the latter.

17. A method for producing a system for the circulation of fluid between at least one first body or housing and at least one second body or housing, this system having an arrangement of multiple fluidic connections between, on the one hand, said first body or housing provided with at least two distinct openings and, on the other hand, at least one second body or housing having distinct openings, each connection establishing a leaktight fluidic connection between an opening of the first body or housing and an opening of the second body or housing, or of one of the second bodies or housings,
wherein said method comprises:
providing a first body or housing, each opening of which is provided with a corresponding straight, curved or angled rigid female manifold, at least one second body or housing, each opening of which is provided with a corresponding rigid male fitting, and rigid ducts or diabolos of suitable shape, configured to be nested, on the one hand, in respective female manifolds of the first body or housing and, on the other hand, on respective male fittings of the second body or housing or of the second bodies or housings, and producing nested manifold/duct/fitting assemblies, formed of mutually nested tubular elements made of rigid plastic material, each forming a leaktight fluidic connection and each provided with at least a limited capability of relative rotational/translational/angular displacement, at least at the relevant nesting, and optionally also at the relevant nesting, so as to obtain fluidic connections of a rigid but articulated type.

18. The method as claimed in claim 17, comprising, in a separate and preliminary operating phase, producing a pre-mounted structural and functional module either by assembling the first body or housing with the different pairs of mutually pre-nested tubular elements manifolds/ducts associated therewith, or by assembling the female manifolds with said first body or housing, then assembling the rigid ducts or diabolos by nesting them with the respectively corresponding manifolds, and then in assembling this module mechanically and fluidically, by mounting in a direction parallel to the central axes of the straight rigid male fittings and multiple nestings of the rigid ducts or diabolos on these fittings, with said at least one second body or housing to form the fluid circulation system.

19. The method as claimed in claim 18, wherein the assembly of the pre-mounted module with said at least one second body or housing is carried out at a robotic station, either in a fully automated manner by an autonomous robot, or in a semi-automated manner by a collaborative or assistance robot.
